(19) United States
(12) Patent Application Publication
(10) Pub. No.: US 2008/0095984 A1
(43) Pub. Date: Apr. 24, 2008

(54) Shingle

(75) Inventor: Michael Desouto, Somerset, MA (US)

Correspondence Address: William;Davis, Building Materials Investment Corporation, 1361 Alps Road, Wayne, NJ, 07470, US

(73) Assignee: Building Materials Investment Corporation

(21) Appl. No.: 11/575,040

(22) PCT Filed: Sep. 9, 2005
(86) PCT No.: PCT/US05/32271

§ 371 Date: Mar. 9, 2007

Related U.S. Application Data
(60) Provisional application No. 60/608,791, filed on Sep. 9, 2004.

(51) Int. Cl. B32B 15/02; B05D 7/00

(52) U.S. Cl. 428/143; 427/186; 428/402

(57) ABSTRACT

A granular composite and roofing material covered by such composite comprising reflective roofing granules and traditional roofing granules to create a granule composite having a total solar reflectance of greater than 0.19, and a CIELAB coordinate L* of less than 75.

### BACKGROUND OF THE INVENTION

1. Field of the Invention

The present invention pertains to asphalt roofing shingles, and more particularly, to the use of special highly reflective colored granules blended with traditional granules to raise the reflectivity of the asphalt roofing shingles.

2. Prior Art

Roofing granules, both natural and artificially color-coated granules, are extensively used in roll roofing and asphalt shingle compositions. The roofing granules are typically embedded in the asphalt coating on the surface of an asphalt impregnated felt base material, the granules thus forming a coating that provides a weather-resistant exterior roofing surface. In addition to its utility, the granule coating also provides an esthetic effect observable with respect to the coating composition, and the appearance of the granules is of major marketing interest.

For this reason a pigmented color coating is ordinarily applied to the base mineral granules to enhance their visual, decorative effect. The method of providing artificially colored roofing granules involves crushing and screening minerals and applying to the so-obtained granules a coating containing the desired pigment. The granules and the pigment are bonded together by using a soluble silicate binder solution which is then insolubilized by heat treatment alone or by chemical action to a water-insoluble state. The function of the soluble silicate is to first uniformly distribute and encapsulate the pigment within the coating matrix and then to bind the pigment and granules together when the silicate is insolubilized.

The soluble silicate binder is converted to an insoluble state by heat treatment as in the case of a silicate/clay coating matrix or by a combination of heat treatment and chemical action such as by the addition of an acidic material to the fired soluble silicate.

Exemplary references directed to the production of artificially colored granules and stabilizing the pigment therein are as follows.

U.S. Pat. No. Re. 20,295 describes artificially colored roofing granules produced by: depositing on granular mineral matter a metal salt followed by the addition of a soluble silicate which will react to form an insoluble metal glass; and subjecting the insoluble metal glass to heat in order to fuse the metal silicate on the granules.

U.S. Pat. No. 2,001,448 describes a method of producing artificially colored granules by the steps of: providing base particles, such as sand, gravel, rock, blast-furnace slags, or burned clay or shale and crushed brick; mixing the particles with a hydrous plastic clay in either wet or dry condition so that the clay coats the exterior surfaces of the particles; adding a suitable color pigment to coat the particles therewith; drying the particles; adding silicate of soda either per se or with a coloring pigment therein to react with the clay coating covering the particles; and heating the particles to a temperature of about 450 degrees to 1200 degrees F. to fuse together the coatings and the particles.

U.S. Pat. No. 2,695,851, describes artificially colored roofing granules and a method for producing them. The method comprises: forming on the base granules a coating of film-forming composition which contains a pigment, an alkali silicate solution, finely-divided hydrated alumina, and an insolubilizing agent comprising of clay, cryolite, feldspar, aluminum fluoride and sodium fluorosilicate; and heating the so-obtained granules to about 1000 degrees F.

The hydrated alumina used in combination with a light-colored, opaque pigment, such as titanium dioxide produces lighter and brighter granules than can be produced with titanium dioxide in the absence of hydrated alumina.

U.S. Pat. No. 2,732,311 is directed to a coating process for producing radiation-reflective roofing granules.

In the process the raw granules are mixed with a clay-like material, such as kaolin at a temperature below 100 degrees F., preferably at room temperature. A solution of sodium silicate is added to the mixture. Alternatively, the clay and sodium silicate can be pre-mixed then applied to the granules. The granules are then partially air-dried to develop a tacky film on the granules. When the proper viscous tacky film has been formed, aluminum flakes are then added to the mixture and are caused to adhere to the coated granules by further mixing. Instead of aluminum flakes, copper flakes, brass flakes, or metallic particles known as bronze powders and aluminum bronze may be used. The metal flake-coated granules are then fired at a temperature of about 900 degrees to 1000 degrees F.

U.S. Pat. No. 2,981,636 describes artificially colored roofing granules and a method for their preparation. The method of producing the colored roofing granules involves the steps of: mixing the cleaned and heated granules with an aqueous solution of sodium silicate; drying and dehydrating the mixture of granules and the aqueous solution; and adding an insolubilizing agent containing a desired pigment therein to the dehydrated granules. The in solubilizing agent is a mixture of aluminum chloride and ammonium chloride, however, other insolubilizing agents may also be used, such as aluminum sulfate, magnesium chloride, zinc chloride, and hydrochloric acid.

It is apparent from the prior art that these asphalt roofing shingles, depending on pigmentation, have not been able to provide a highly reflective, “cool”, non-white, roofing surface so the shingles do not absorb excessive heat in order to conserve energy. Past attempts have produced colored granules of poor reflective characteristics exhibiting rapid loss of color and less reflectivity.

### SUMMARY OF THE INVENTION

The asphalt roofing shingle of the present invention provides for the use of highly reflective colored granules blended with traditional granules to raise the reflectivity characteristics of the asphalt roofing shingles. The reflectivity provided by the inventive granule composition, meets Energy Star® standards.

In the preferred embodiment of the invention, granules designated as 507 yellow and 707 white were used on sample boards. The resulting granule composition has an initial solar reflectance and a maintained solar reflectance that meets today's Energy Star® criteria.

The energy efficacy of the inventive granule composition is determined by its solar reflectance. Solar reflectance by definition is the fraction of solar flux reflected by a surface expressed as a percent or within the range of 0.00 and 1.00.

The above and other features of the invention, including various novel details of construction and combinations of parts, will now be more particularly described with reference to the accompanying sheets. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE FIGURES

FIGS. 1-5 are graphs of the color blends tested for the total solar reflectance (TSR), and CIELAB coordinates.

### DETAILED DESCRIPTION OF THE PREFERRED EMBODIMENT

Although this invention is applicable to numerous and various roofing structures, it has been found particularly useful in the environment of colored granules used for asphalt roofing shingles. Therefore, without limiting the applicability of the invention to colored granules for asphalt roofing shingles, the invention will be described in such environment. With reference now to the drawings, the components of the present invention will be described.

Roofing granules are generally embedded in the asphalt coating on the surface of the asphalt-impregnated felt base material, so that the granules from a protective layer to shield the asphalt from the actinic rays of the sun. As this outer granule layer also provides an observable aesthetic effect, the reflectivity of the granules is of major importance as well. Thus, a pigmented color coat can be applied to the base mineral granules to enhance their reflectivity characteristics as well as to provide a visual, decorative effect.

Methods for artificial coloring of roofing granules involve crushed and screened minerals in which the granules are coated with a pigment of choice in a silicate matrix. The coating composition contains a soluble alkali silicate binder which is insolubilized by heat treatment or by chemical action or a combination thereof. Insolubilization by chemical action typically involves the addition of an acidic material to the soluble alkali silicate after heat treatment.

It is a main object of the present invention to raise the reflectivity of roofing material, preferably asphalt roofing shingles, by using special highly reflective granules, preferably bright white and/or yellow granules, blended with traditional granules to create a granule composite. Roofing shingles comprising felt or fabric stock impregnated with asphalt and covered with weather resistant mineral granules are well known. They have served as relatively inexpensive alternatives to tile, slate and wood roofing shingles. Asphalt shingles are fire-resistant, provide good weather protection and are renownedly durable.

As indicated above, the present invention provides a granule composition for roofing materials that provides energy efficiency, durable exterior protection, is highly reflective to solar energy, and which is applied during the manufacture of the roofing shingles. The highly reflective nature of the granule composition of the present invention provides a solar reflective shingle that minimizes energy expended in air conditioning and levels temperature within a building structure.

Reflectivity is defined as the fraction of radiant energy that is reflected from the white roofing surface. The higher the amount of reflectivity the cooler to roof has the capability of being.

The energy efficacy of the coating is determined by measuring its initial solar reflectance using ASTM E903 (Standard test method for solar absorptance, reflectance, and transmission of materials using integrated spheres). Alternatively, the initial solar reflectance can be determined by ASTM C 1549 (Standard test method for determination of solar reflectance near ambient temperature using a portable reflectometer).

In addition to having the aforementioned initial solar reflectance values, the coating of the present invention needs to be capable of maintaining a solar reflectance for three years after installation under normal conditions of greater than or equal to 0.15 (measured from the first year after installation).

Maintenance of solar reflectance of a roofing product can be determined using the current guidelines mentioned in the Energy Star® program requirements manual. The test can be carried out using ASTM E 1918 or ASTM C 1549 for low-sloped roofing products. ASTM C 1549 can be used in the case of steep-sloped roofing.

Any suitable base raw mineral granules commonly employed, such as greenstone, rhyolite, andesite, basalt, and nephaline syanite can be used in the present invention. Artificially colored granules, which are commonly employed by the building material industry, can be another source of the starting material. With respect to the artificially colored granules, an alkali metal silicate-clay coating is applied to the base mineral granules and fired to produce a substantially water-insoluble, pigmented coating on the base mineral granules.

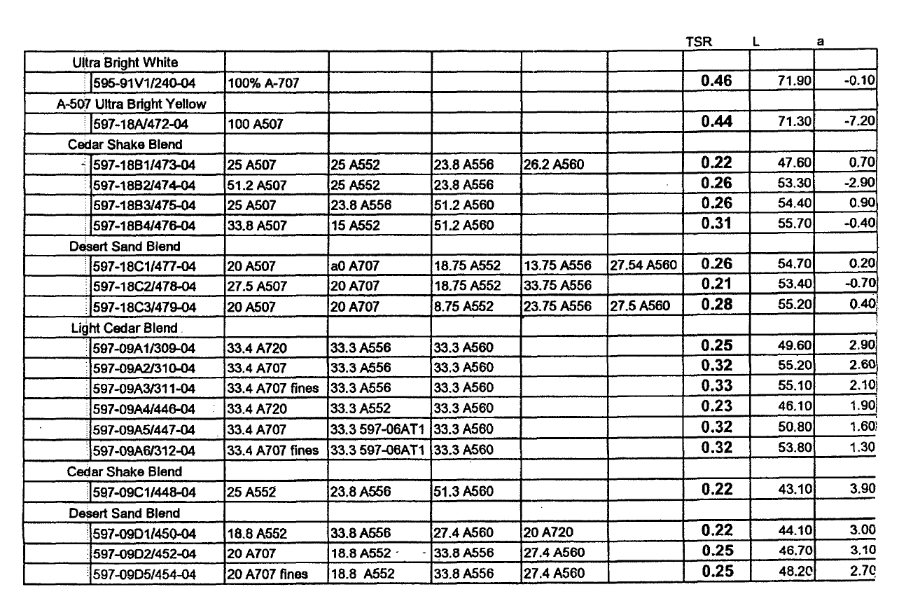

As in the above alkali metal silicate-clay coating, the granules may be rendered colored by using various pigments, such as 507 yellow and 707 white, and the other pigments identified in FIG. 1.

An illustrative process of making colored roofing granules comprises the steps of crushing and sizing the base aggregate to the desired size, typically to No. 11 grading, pre-heating the sized/graded granules to about 210 degrees-230 degrees F., coating the pre-heated granules with a ceramic composition being in the form of aqueous slurry comprising: alkali silicate, preferably sodium silicate, Kaolin clay and pigment, pre-drying the coated granules to adjust their moisture content to about 0.2% to 0.5% w/w, and kiln-firing the granules at a temperature of from about 940 degrees F. to about 960 degrees F. to form an insolubilized silicate-clay matrix coating.

In asphalt roofing compositions the colored granules are employed in commercially established quantities, e.g. generally on the order of about 35 pounds of granules per square or 100 ft.sup.2 of shingle butt portion. The exact amount of granules employed may vary depending on the particular operations of a given roofing manufacturer, the particular shingle or other roofing product involved and other pertinent factors relating to any specific roofing operation.

The granule composite of the present invention is applied in any known manner. Typically the granules are applied in a section of the manufacturing line that usually consists of a multi-compartmented granule hopper, two parting-agent hoppers, and two large press rollers. The hoppers are fed by machine bins above the line. The granule hopper drops colored granules from its various compartments onto the top surface of the moving sheet of coated web in the sequence necessary to produce the desired color pattern on the roofing. The coated sheet is then cooled, cut and packaged.

The enclosed figures have inventive granule blends that are expected to be Energy Star compliant based on the reflectance values determined on the panels. Also in the figures are the appropriate “similar in appearance” but likely not Energy Star compliant blends based on standard granules.

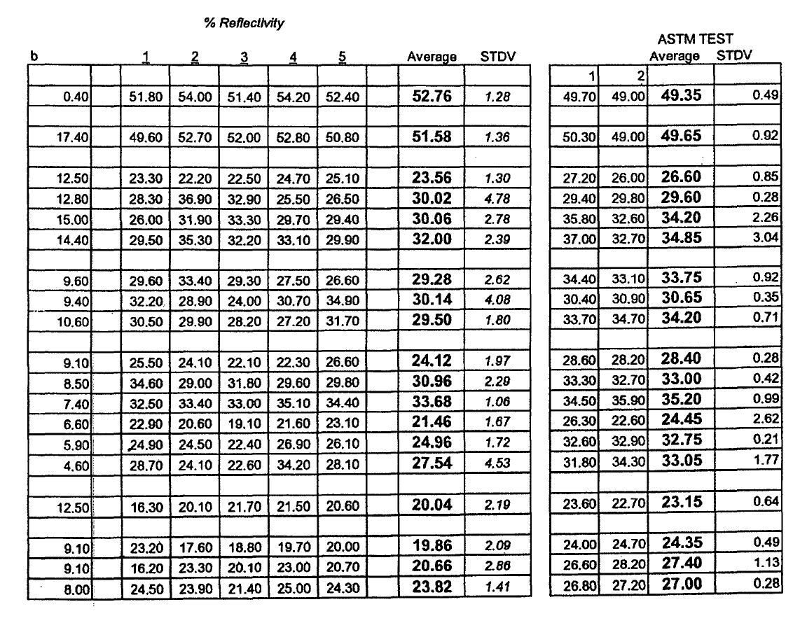

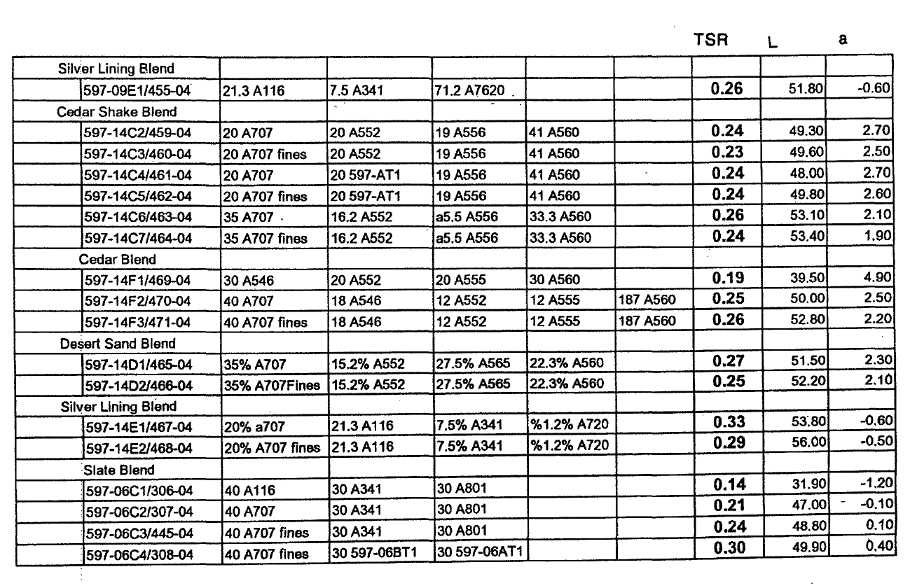

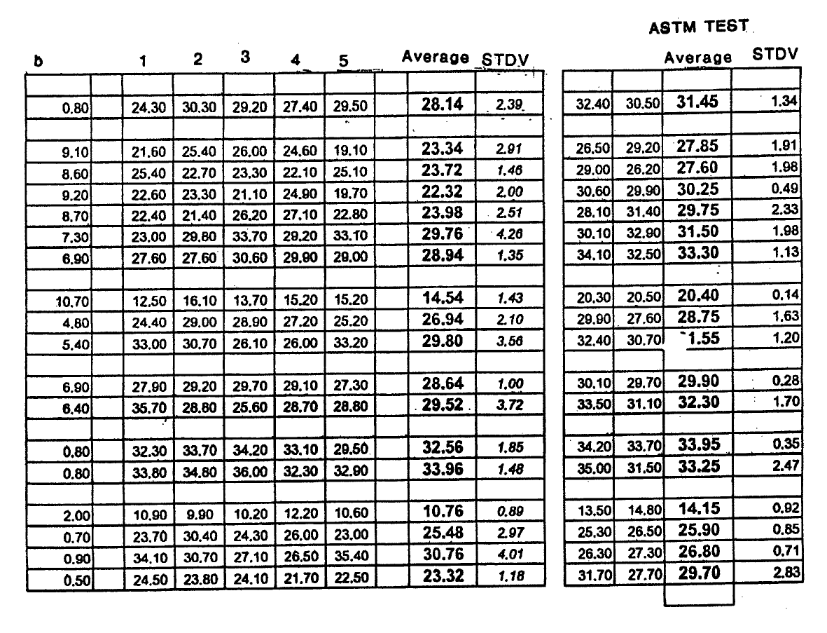

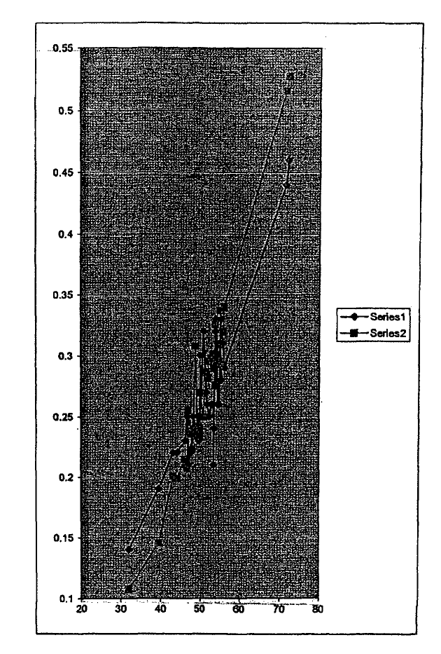

The figures show charts and graphs of the color blends tested for the total solar reflectance (TSR), and the CIELAB coordinates L* for lightness with 0 being black, 100 being white, a* for redness-greenness with positive values indicating redness and negative greenness, and b*, for yellowness (positive) and blueness (negative). It is clear from the results in the chart that using special highly reflective bright white and/or yellow (507 yellow and 707 white) granules blended with traditional granules can raise the reflectivity of asphalt roofing shingles while also maintaining a colored shingle. FIG. 2 is a continuation of FIG. 1, FIG. 4 is a continuation of FIG. 3.

The preferred embodiment of the present invention is a roofing material comprising reflective granules and traditional granules to create a granule composite having a total solar reflectance of greater than 0.19, and a CIELAB coordinate L* of less than 75. In the preferred embodiments, the percentage of 507 yellow granules or 707 white granules used relative to the total granular composite is less than or equal to 20%.

Another preferred embodiment of the present invention is a method of manufacturing a roofing shingle comprising the steps of providing an asphalt coated sheet; depositing a granule composite of reflective roofing granules and traditional roofing granules to create a granule composite having a total solar reflectance of greater than 0.19, and a CIELAB coordinate L* of less than 75 on the sheet, cooling the sheet, and cutting the sheet by a cutting cylinder to produce a shingle of known length and width. The roofing shingle may be multi-layered.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated.

We claim:

1. A granular composite comprising:
reflective roofing granules and traditional roofing granules to create a granule composite having a total solar reflectance of greater than 0.19, and a CIELAB coordinate L* of less than 75.

2. A granular composite as in claim 1 wherein:
the reflective granules are pigmented 507 yellow and 707 white.

3. A granular composite as in claim 2 wherein:
the percentage of 507 yellow granules used relative to the total granular composite is less than or equal to 20%.

4. A granular composite as in claim 2 wherein:
the percentage of 707 white granules used relative to the total granular composite is less than or equal to 20%.

5. A roofing material comprising:
reflective roofing granules and traditional roofing granules to create a granule composite having a total solar reflectance of greater than 0.19, and a CIELAB coordinate L* of less than 75.

6. A roofing material as in claim 5 wherein:
the reflective granules are pigmented 507 yellow and 707 white.

7. A roofing material as in claim 6 wherein:
the percentage of 507 yellow granules used relative to the total granular composite is less than or equal to 20%.

8. A roofing material as in claim 6 wherein:
the percentage of 707 white granules used relative to the total granular composite is less than or equal to 20%.

9. A roofing shingle comprising:
reflective roofing granules and traditional roofing granules to create a granule composite having a total solar reflectance of greater than 0.19, and a CIELAB coordinate L* of less than 75.

10. A roofing shingle as in claim 9 wherein:
the reflective granules are pigmented 507 yellow and 707 white.

11. A roofing shingle as in claim 10 wherein:
the percentage of 507 yellow granules used relative to the total granular composite is less than or equal to 20%.

12. A roofing shingle as in claim 10 wherein:
the percentage of 707 white granules used relative to the total granular composite is less than or equal to 20%.

13. A roofing shingle as in claim 9 wherein the shingle is multi-layered.

14. A method of manufacturing a roofing shingle comprising the steps of:
providing an asphalt coated sheet; depositing a granule composite of reflective roofing granules and traditional roofing granules to create a granule composite having a total solar reflectance of greater than 0.19, and a CIELAB coordinate L* of less than 75 on the sheet, cooling the sheet, and cutting the sheet by a cutting cylinder to produce a shingle of known length and width.

15. A method as in claim 14 wherein:
the reflective granules are pigmented 507 yellow and 707 white.

16. A method as in claim 15 wherein:
the percentage of 507 yellow granules used relative to the total granular composite is less than or equal to 20%.

17. A method as in claim 15 wherein:
the percentage of 707 white granules used relative to the total granular composite is less than or equal to 20%.

18. A method as in claim 14 wherein:
the shingle is multi-layered and the granule composite is deposited on at least one layer.
